(19) United States
(12) Patent Application Publication
(10) Pub. No.: US 2003/0014528 A1
(43) Pub. Date: Jan. 16, 2003

(54) Light-weight protocol-independent proxy for accessing distributed data

(76) Inventors: Paul D. Crutcher, Hillsboro, OR (US); Xihong Wang, Portland, OR (US); Joshua R. Williams, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/904,646

(22) Filed: Jul. 12, 2001

(51) Int. Cl. G06F 15/16

(52) U.S. Cl. 709/229

(57) ABSTRACT

Transparent access to networked resources identified with a resource locator that is at least partially obscured. When a resource locator is received, for example, by a proxy, client authorization to access the resource is validated. If the client is authorized, then the at least partial obscuring is do-obscured and the resource is retrieved from the resource manager according to the de-obscured resource locator. Even if the client is using a protocol that would normally identify the source of the resource, the resource is provided to the client as if it originated with the proxy. In such manner, the location of the resource manager may remain hidden.

### FIELD OF THE INVENTION

The invention generally relates to accessing resources behind a firewall or other secure environment, and more particularly to a service that recognizes an at least partially encrypted resource reference, e.g., Uniform Resource Locators (URLs), where the service acts as a proxy to obtain a resource identified by the resource reference.

### BACKGROUND

With the proliferation of Internet and other network connections, it has become commonplace for a business to place servers on a network, and then serve data to clients. Typically different servers are used to provide different types of data, and for high-volume servers, such as a web server for a popular web site, multiple servers may be used to serve the same data to incoming client connections.

Unfortunately, while one wants to provide general access to a server, in recent times it has become necessary to secure network servers from intrusions, attacks, or other undesirable access. Providing robust protection, in conjunction with allowing general access, is a difficult issue to resolve. Generally protecting a server requires individual attention to the server. For a business having many servers, the resources required to properly protect the servers can become prohibitively expensive. In addition, protecting servers may be an error prone process, which may result in servers having differing security configurations, or in a worse case, no protection at all.

### BRIEF DESCRIPTION OF THE DRAWINGS

The features and advantages of the present invention will become apparent from the following detailed description of the present invention in which:

FIG. 1 is a system data-flow diagram according to one embodiment of the invention.

FIG. 2 is a flow-chart illustrating an exemplary implementation of the FIG. 1 system.

FIG. 3 illustrates an exemplary format for a Uniform Resource Locator (URL).

FIG. 4 is a flow-chart of an exemplary embodiment of the FIG. 1 system, in which a client utilizes a network application program using the HyperText Transfer Protocol.

FIG. 5 illustrates a suitable computing environment in which certain aspects of the invention may be implemented.

### DETAILED DESCRIPTION

In the following description, various exemplary embodiments of the invention are disclosed. The illustrated embodiments allow one to take advantage of an existing network infrastructure, e.g., a server network, without requiring all servers within the network to be individually secured for direct client access. Instead, data access for data stored on the servers is routed through one or more central access points, or “front end servers,” which in turn regulate, and translate if required, client accesses to data stored by the servers.

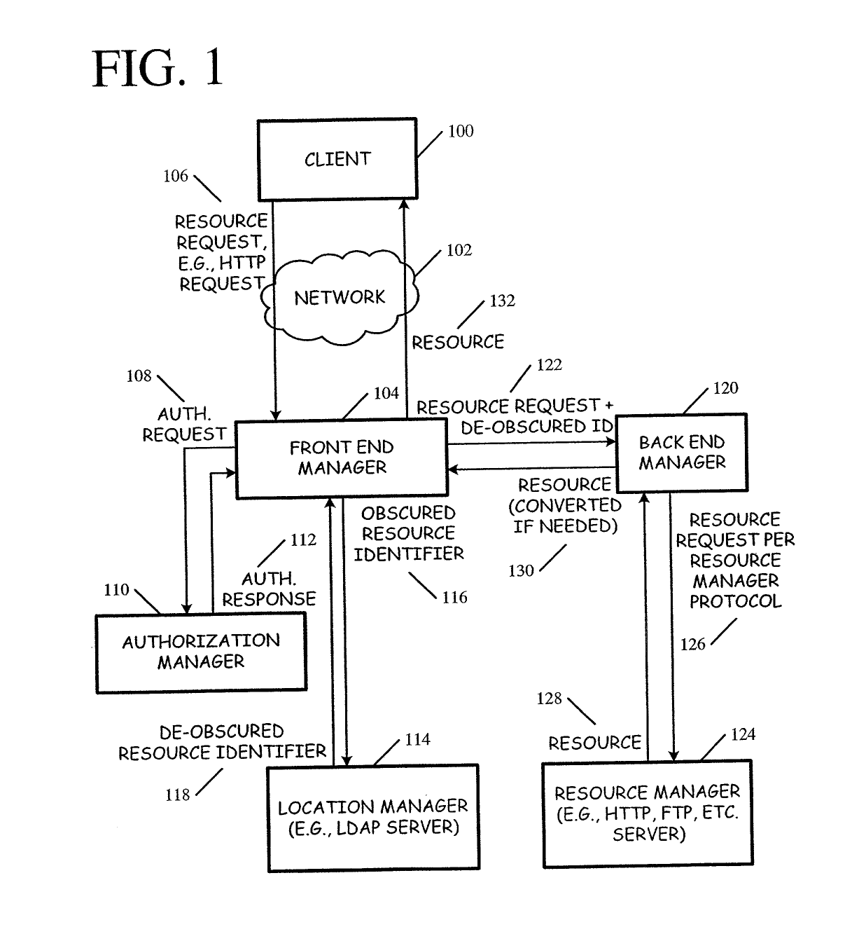

FIG. 1 is a system data-flow diagram according to one embodiment of the invention. Note that although this figure depicts several different managers 104, 110, 114, 120, 124, it will be appreciated that these managers and their operations may be variously separated and combined into more or fewer managers than as illustrated. The illustrated separation is to facilitate describing various aspects of the invention, and is not intended to limit or otherwise proscribe potential configurations for the invention. It will further be appreciated that managers may be implemented as separate servers, or within a server, e.g., as a filter, dynamic link library (DLL), service, daemon, etc.

A client 100, e.g., a machine executing an Internet browser or other networking application program, communicates through a network 102 to a front end manager 104. The front end manager acts as an access point for requests 106, e.g., HyperText Transfer Protocol (HTTP) requests, data access requests, or other protocol requests issued by the client. When a request requiring processing by the invention is received, the front end manager validates the request, and possibly and associated identity of the client, by sending an authorization request 108 to a authorization manager 110. The authorization manager sends an authorization response 112. In one embodiment, the associated identity for a client is hash encoded to reduce resources required to track and authenticate clients.

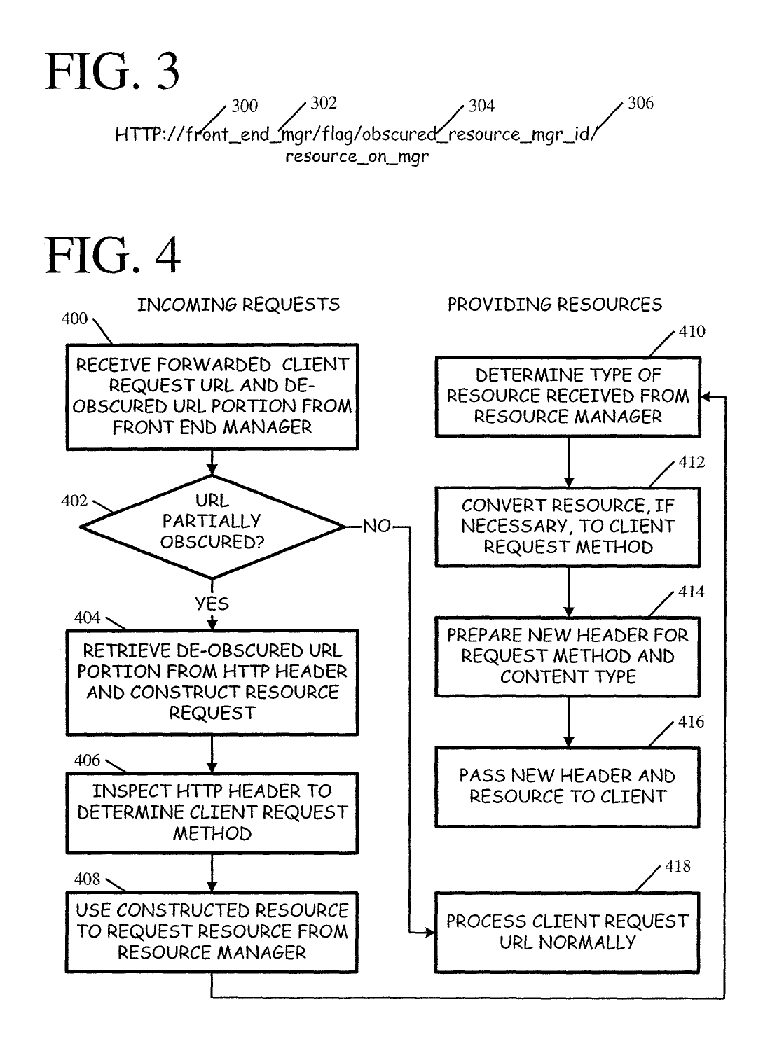

In one embodiment, an HTTP-type communication protocol is utilized, and the client request 106 comprises an Internet Uniform Resource Locator (URL), where some or all of the URL path components include an identifier indicating intervention by the invention is desired. In one embodiment, a pre-determined URL path component trigger is used. For example, a URL may be formatted as in FIG. 3, where the URL comprises a reference 300 to the front end manager, a flag 302 indicating the URL comprises an obscured portion requiring special handling, an obscured portion 304, e.g., by way of a globally unique identifier (GUID), encryption, embedding, etc. mapping the address for a hidden resource manager 124, and an identifier 306 for the desired resource of the hidden resource manager.

While the front end manager 104 authorizes the client request, the front end manager also passes the client request, or just the obscured portion 116 thereof, to a location manager 114 for determination of a corresponding de-obscured resource identifier 118. In one embodiment, the location manager communicates by way of the Lightweight Directory Access Protocol (LDAP), the International Organization for Standardization/International Telecommunication Union (ISO/ITU) X.500 protocol, or other access protocol known in the art. In an alternate embodiment, rather than the front end manager seeking the de-obscured identifier from the location manager, instead the authorization manager 110 forwards the client request, or just the obscured portion thereof, to the location manager.

Once the front end manager 104 receives the de-obscured resource identifier 118 from the location manager 114, the front end manager can request the resource from a back end manager 120. It will be appreciated that the front end manager and the back end manager may be embodied within a single machine. For example, as noted above, the front and back end managers may be operating as filters or DLLs within a single server. In one embodiment, multiple back end managers, not shown, may be storing the desired resource, and that known techniques for selecting one of the multiple managers may be employed. In addition, portions of a desired resource may be obtained in parallel or in series from several different managers, either automatically, or through identifiers within the client request 106.

As discussed above, the client request 106 is made according to some protocol, e.g., HTTP or otherwise. The front end manager 104 receives the client request and creates a new request 122 comprising portions of the client request 106 (see, e.g., FIG. 3 item 306) and the de-obscured resource identifier 118. The new request is forwarded to the back end manager 120 for processing. In one embodiment, the new request is constructed such that it appears to originate from the front end manager, rather than from client 100. In this embodiment, assuming the back end manager is applying security validation to incoming requests, the back end manager need only be configured to authenticate known front end managers.

The back end manager 120 requests 126 the desired resource from resource manager 124 storing the resource. Note that the resource manager may be storing the desired resource in a format different from that identified in the client request 106. For example, the client may request a Moving Picture Experts Group (MPEG) encoding of a video, whereas the resource manager is storing the video as a Microsoft Corporation Audio Video Interleave (AVI) encoding, motion Joint Photographic Experts Group (JPEG) encoding, Apple Computer QuickTime encoding, or the like. Note that a firewall, not illustrated, may insulate the resource manager 124 from access.

In the illustrated embodiment, the back end manager issues a resource request 126 according to the encoding format utilized by the resource manager, e.g., issues a request 126 for an AVI encoding of the desired resource. The resource manager returns the requested resource 128, which is then converted 130, if necessary, into the format requested by the client 100, and then returned 132 by the front end manager to the client. In an alternate embodiment, the resource manager 124 converts the resource as necessary for the client.

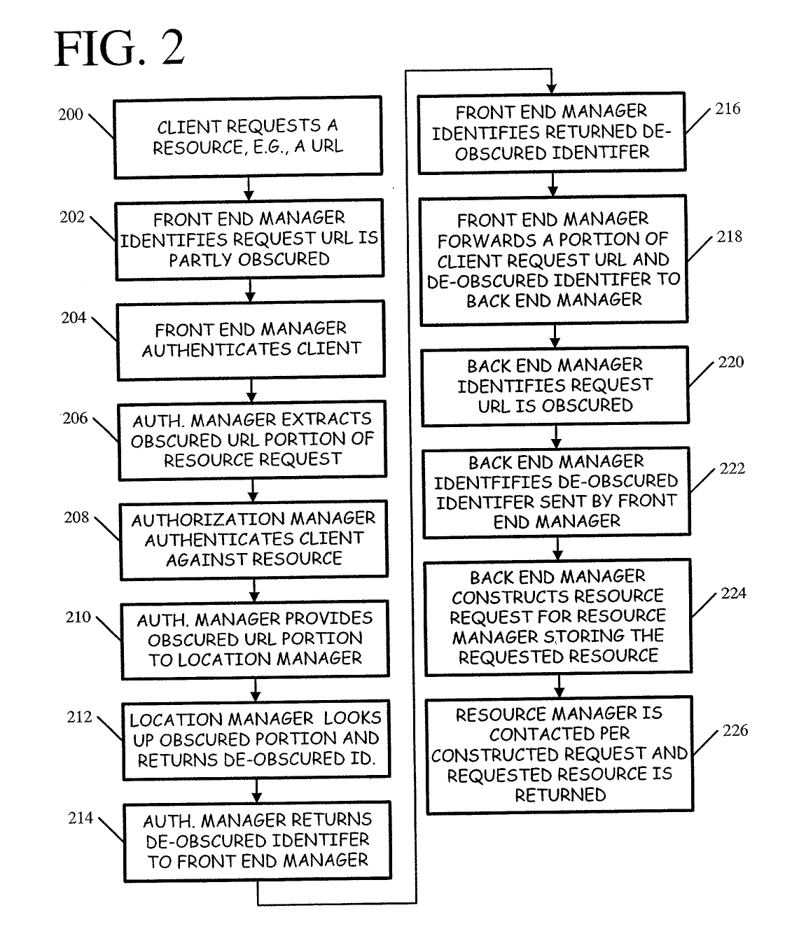

FIG. 2 is a flow-chart illustrating one implementation of the FIG. 1 system.

A client 100 requests 200 a resource, such as by way of selecting a URL or equivalent with a network application program such as an Internet browser. When the client selects a URL, it is assumed the selected URL is provided to a front end manager 104. The front end manager identifies 202 that a portion of the URL is at least partially obscured, e.g., mapped or otherwise encoded. If the front end manager 104 does not identify an obscured portion (e.g., FIG. 3 item 304) of the URL, then the URL is processed in a conventional manner.

The front end manager authenticates 204 the client 100 to ensure the client may request resources by way of the front end manager 104. In an alternate embodiment, the front end manager is a public access manager not requiring authentication. The front end manager may log (not shown) client access and requests to the front end manager. The front end manager also provides the resource request to a authorization manager 110, which, in the illustrated embodiment, extracts 206 the obscured URL portion of the resource request. The authorization manager authenticates 208 the client against the resource desired by the client. And, the obscured portion is forwarded 210 to a location manager 114. In contrast with FIG. 1, as illustrated, the location manager returns 212 a corresponding de-obscured identifier or value for the obscured portion to the authorization manager, which in turn returns 214 it to the front end manager.

The front end manager identifies 216 passing of the de-obscured resource identifier, and forwards 218 the client's resource request 106 (or FIG. 3 item 306) and corresponding de-obscured identifier 118 to a back-end manager 120. In an alternate embodiment, the front end manager only forwards 218 the de-obscured portion and the resource request. The back end manager identifies 220 the resource request URL is obscured, and therefore looks for the de-obscured identifier being passed to it. In one embodiment, the back end manager constructs 224 a valid resource request for a resource manager 124 storing the resource 128 by constructing a new URL by combining the de-obscured identifier 118 and the FIG. 3 identifier 306.

The resource manager is contacted 226 with the constructed resource request. The resource manager retrieves the resource and returns 226 it to the back end manager, which in return passes it back front end manager for passing back to client 100. When implemented in accordance with principles of the invention, such processing behind the front end manager is transparent to the requesting client. Such transparent processing relieves management burdens for resource managers, since the resource managers may be hidden behind a firewall or other protective environment.

Note that FIG. 2 discussion does not require a particular communication protocol, e.g., HTTP. However, as will be discussed below with respect to FIG. 4, if HTTP is utilized, then the client request 106 has an associated HTTP header indicating the nature of the client request, e.g., the Request-Method, etc. The header is passed between client 100 and managers 104, 110, 114, 120, 124, and contains the original client request 106 and the corresponding de-obscured identifier when determined by the location manager 114.

The front end manager parses the received HTTP header to identify 216 the de-obscured resource identifier, and forwards 218 the client resource request URL and de-obscured identifier, within an HTTP header, to a back-end manager 120. When the back end manager identifies 220 that the resource request URL is obscured, it inspects the HTTP header to identify 222 the de-obscured identifier within the HTTP header. In one embodiment, the back end manager creates a new header (or set of headers) so that it appears the client request 106 originates from the back end manager. Thus, rather than requiring the resource manager to recognize all clients, instead, the resource manager need only be configured to authenticate back end managers.

FIG. 4 is a flow-chart according to one exemplary embodiment of the FIG. 1 system invention in which a client 100 utilizes a network application program, such as an Internet browser, using the HTTP communication protocol to communicate with manager 104. The figure is arranged into two portions, a first comprising operations 400-408 corresponding to incoming requests for a resource, and a second comprising operations 410-420 corresponding to providing requested resources.

In the illustrated embodiment, URLs reference obscured resources stored by resource managers 124, and mapping is utilized to obscure references to the resource managers within the URLs (see FIG. 3). When a request is received, HTTP headers are received from a front end manager 104 by a back end manager 120 that comprise a forwarded 400 client request 106 URL, and a header for the corresponding de-obscured URL portion. A test 402 is performed to determine whether the URL is at least partially obscured. If not, then the client request is processed 418 in a conventional manner.

If so, headers are parsed and the de-obscured URL portion retrieved from the headers, and a portion of the original resource request 106 (e.g., FIG. 3 item 306) is combined with the de-obscured URL portion to construct 404 a valid resource request for a resource on a resource manager 124. As noted above, the client 100 can be left unaware of the processing occurring behind the front end manager 104, and unaware of the location of the resource manager storing the desired resource. This greatly simplifies security precautions that need to be taken for the managers, as only the front end manager is directly exposed to the clients.

The HTTP headers are inspected to determine 406 the client request method. The constructed 404 de-obscured resource request is used to request 408 the resource from a resource manager. Note that the request may be for only a portion of a resource, such as to allow parallel operations to expedite obtaining a resource from one or more resource managers.

When the back end manager 120 receives the desired resource from the resource manager 124, the format of the received resource is inspected to determine 410 the content type received from the resource manager. In one embodiment, the received resource has associated protocol specific meta-data to facilitate the determination 410, e.g., HTTP headers for the HTTP protocol. The resource is converted 412, if necessary, to the format originally requested by the client 100. To maintain client unawareness of the processing occurring behind the front end manager 104, new HTTP headers are prepared 414 so that the new headers and the resource can be passed 416 to the client as if coming from the front end manager responsive to the client's initial resource request 106.

Note that FIGS. 2 and 4 were described with reference to FIG. 1, and may make specific reference to communication protocols or other details. These limitations are not intended to impute limitations to FIG. 1, and are instead intended to represent particular possible embodiments according to FIG. 1.

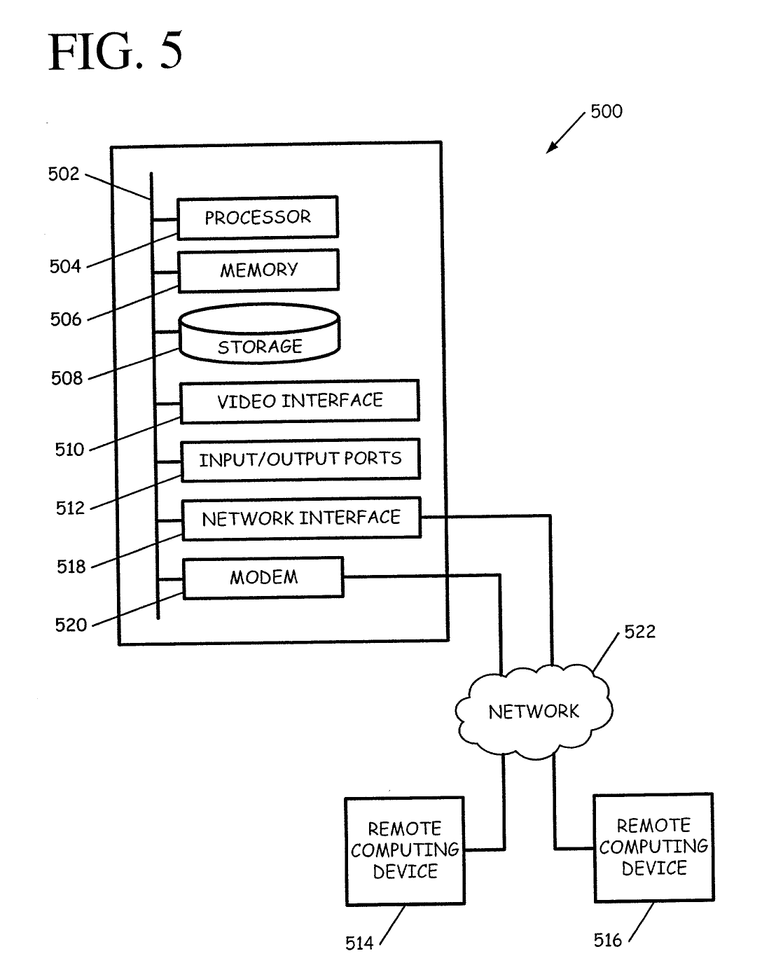

FIG. 5 and the following discussion are intended to provide a brief, general description of a suitable computing environment in which certain aspects of the illustrated invention may be implemented. An exemplary system for embodying, for example, FIG. 1 client 100, or managers 104, 110, 114, 120, 124, includes a machine 500 having system bus 502 for coupling various machine components. Typically, attached to the bus are processors 504, a memory 506 (e.g., RAM, ROM), storage devices 508, a video interface 510, and input/output interface ports 512.

The system may also include embedded controllers, such as Generic or Programmable Logic Devices or Arrays (PLD, PLA, GAL, PAL), Field-Programmable Gate Arrays (FPGA), Application Specific Integrated Circuits (ASIC), single-chip computers, smart cards, etc. The system is expected to operate in a networked environment using physical and/or logical connections to one or more remote systems 514, 516 through a network interface 518, modem 520, or other pathway. Systems may be interconnected by way of a wired and/or wireless networks, including an intranet, the Internet, local area networks, wide area networks, cellular, cable, laser, satellite, microwave, “Blue Tooth” type networks, optical, infrared, or other carrier.

The invention may be described by reference to program modules for performing tasks or implementing abstract data types, e.g., procedures, functions, data structures, application programs, etc., that may be stored in memory 506 and/or storage devices 508 and associated storage media, e.g., hard-drives, floppy-disks, optical storage, magnetic cassettes, tapes, flash memory cards, memory sticks, digital video disks, biological storage, as well as transmission environments such as network 522 over which program modules may be delivered in the form of packets, serial data, parallel data, or other transmission format.

Illustrated methods and corresponding written descriptions are intended to illustrate machine-accessible media storing directives, or the like, which may be incorporated into single and multi-processor machines, portable computers, such as handheld devices including Personal Digital Assistants (PDAs), cellular telephones, etc. An artisan will recognize that program modules may be high-level programming language constructs, or low-level hardware instructions and/or contexts, that may be utilized in a compressed or encrypted format, and may be used in a distributed network environment and stored in local and/or remote memory.

Thus, for example, with respect to the illustrated embodiments, assuming machine 500 operates as client 100, then remote devices 514, 516 may respectively be a server embodying a front end manager 104 and a server embodying a back end manager 120. It will be appreciated that remote machines 514, 516 may be configured like machine 500, and therefore include many or all of the elements discussed for machine. It should also be appreciated that machines 500, 514, 516 may be embodied within a single device, or separate communicatively-coupled components.

Having described and illustrated the principles of the invention with reference to illustrated embodiments, it will be recognized that the illustrated embodiments can be modified in arrangement and detail without departing from such principles. And, even though the foregoing discussion has focused on particular embodiments, it is understood other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments, and unless indicated otherwise, embodiments are combinable into other embodiments.

Consequently, in view of the wide variety of permutations to the above-described embodiments, the detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for a proxy to transparently provide access to resources of a resource manager, comprising:
receiving from the client a resource locator for retrieving a resource of the resource manager, wherein the resource locator comprises a network address of the resource manager and the resource locator is at least partially obscured to hide the network address;
validating client authorization to access the resource;
de-obscuring the resource locator;
retrieving the resource from the resource manager according to the de-obscured resource locator; and
providing the resource to the client such that it appears to have originated from the proxy:

2. The method of claim 1, wherein the proxy comprises a front end manager and a back end manager, the method further comprising:
receiving a first proxy header corresponding to the request, the first proxy header identifying the client as the source of the request and the front end manager as the source of the resource; and
preparing a second proxy header by rewriting the first proxy header so as to substitute the back end manager for the client, and the resource manager for the front end manager;
wherein retrieving the resource from the resource manager comprises the back end manager providing the second proxy header to the resource manager.

3. The method of claim 1, further comprising:
receiving a first proxy header corresponding to the request, the first proxy header identifying the client as the source of the request and the proxy as the source of the resource; and
preparing a second proxy header by rewriting the first proxy header so as to substitute the proxy for the client, and the resource manager for the proxy;
wherein retrieving the resource from the resource manager comprises providing the second proxy header to the resource manager.

4. The method of claim 3, further comprising:
receiving a third proxy header from the resource manager, the third proxy header identifying the resource manager as the source of the resource, and the proxy as the recipient of the resource; and
preparing a fourth proxy header by rewriting the third proxy header so as to substitute the proxy as the source of the resource, and the client as the recipient of the resource;
wherein providing the resource to the client comprises providing the fourth proxy header to the client.

5. The method of claim 3, wherein proxy headers are written according to a tag based protocol.

6. The method of claim 5, wherein the tag based protocol is a selected one of: the HyperText Transport Protocol (HTTP), the HyperText Markup Language (HTML), and the extensible Markup Language (XML).

7. The method of claim 3, wherein the first proxy header comprises a content type identifier identifying a desired format for the resource, and wherein the resource manager stores the resource in a second format different from the desired format, the method further comprising:
converting the resource from the second format to the first format.

8. The method of claim 1, further comprising:
receiving a content type identifier from the client identifying a desired format in which to provide the resource to the client; and
converting the resource from a different format utilized by the resource manager into the desired format.

9. The method of claim 1, wherein the network comprises multiple resource managers providing access to the resource, the method further comprising:
retrieving portions of the resource from selected ones of the multiple resource managers.

10. The method of claim 9, wherein the portions are retrieved in parallel from the selected ones of the multiple resource managers.

11. The method of claim 10, further comprising:
determining loads for the multiple resource managers; and
selecting among the multiple resource managers according to the loads.

12. The method of claim 11, wherein the portions are non-overlapping portions of the resource.

13. The method of claim 1, further comprising:
the resource locator comprising a Uniform Resource Locator (URL); and
inspecting the URL for a path component indicating the URL comprises the at least partially obscured portion.

14. The method of claim 1, wherein de-obscuring the resource locator comprises providing at least the obscured portion of the resource locator to a location manager, and receiving a de-obscured identifier responsive thereto.

15. The method of claim 14, wherein the location manager performs the validating client authorization to access the resource.

16. The method of claim 1, wherein validating client authorization to access the resource comprises providing the at least partially obscured portion of the resource locator, and an identity identifier for the client to an authorization manager.

17. The method of claim 1, wherein validating client authorization to access the resource comprises:
hash-encoding an identity value associated with the client; and
providing the hash-encoded identity value and at least a portion of the resource locator to an authorization manager configured to look up the hash-encoded identity value and the at least a portion of the resource locator in an access control table.

18. The method of claim 1, wherein the client communicates with the proxy by way of an Internet browser.

19. The method of claim 1, wherein the proxy comprises a front end manager and a back end manager, wherein the client only communicates with the front end manager for obtaining the resource, and wherein the back end manager obtains the resource from the resource manager.

20. A system, comprising:
a network communicatively coupling a client, a resource manager providing access to its resources, and a proxy comprising a front end manager and a back end manager, wherein the proxy is configured to perform a method comprising:
receiving from the client a resource locator for retrieving a resource of the resource manager, wherein the resource locator comprises a network address of the resource manager and the resource locator is at least partially obscured to hide the network address;
validating client authorization to access the resource;
de-obscuring the resource locator;
retrieving the resource from the resource manager according to the de-obscured resource locator; and
providing the resource to the client such that it appears to have originated from the proxy.

21. The system of claim 20, wherein the proxy is further configured to perform:
receiving a first proxy header corresponding to the request, the first proxy header identifying the client as the source of the request and the proxy as the source of the resource; and
preparing a second proxy header by rewriting the first proxy header so as to substitute the proxy for the client, and the resource manager for the proxy;
wherein retrieving the resource from the resource manager comprises providing the second proxy header to the resource manager.

22. The system of claim 21, wherein the proxy is further configured to perform:
receiving a third proxy header from the resource manager, the third proxy header identifying the resource manager as the source of the resource, and the proxy as the recipient of the resource; and
preparing a fourth proxy header by rewriting the third proxy header so as to substitute the proxy as the source of the resource, and the client as the recipient of the resource;
wherein providing the resource to the client comprises providing the fourth proxy header to the client.

23. The system of claim 20, wherein the resource locator comprises a Uniform Resource Locator (URL), and wherein the proxy is further configured to perform:
inspecting the URL for a path component indicating the URL comprises the at least partially obscured portion.

24. The system of claim 20, wherein validating client authorization to access the resource comprises:
hash-encoding an identity value associated with the client; and
providing the hash-encoded identity value and at least a portion of the resource locator to an authorization manager configured to look up the hash-encoded identity value and the at least a portion of the resource locator in an access control table.

25. The system of claim 20, wherein the client communicates with the proxy by way of an Internet browser.

26. A machine accessible medium having instructions encoded thereon, which when executed by at least one processor, are capable of directing the at least one processor to perform:
receiving from a client a resource locator for retrieving a resource of a resource manager, wherein the resource locator comprises a network address of the resource manager and the resource locator is at least partially obscured to hide the network address;
validating client authorization to access the resource;
de-obscuring the resource locator;
retrieving the resource from the resource manager according to the de-obscured resource locator; and
providing the resource to the client such that it appears to have originated from the proxy.

27. The medium of claim 26, wherein the proxy comprises a front end manager and a back end manager, and wherein the instructions comprise further instructions capable of directing the at least one processor to perform:
receiving a first proxy header corresponding to the request, the first proxy header identifying the client as the source of the request and the front end manager as the source of the resource; and
preparing a second proxy header by rewriting the first proxy header so as to substitute the back end manager for the client, and the resource manager for the front end manager;
wherein retrieving the resource from the resource manager comprises the back end manager providing the second proxy header to the resource manager.

28. The medium of claim 26, wherein the instructions comprise further instructions capable of directing the at least one processor to perform:
receiving a first proxy header corresponding to the request, the first proxy header identifying the client as the source of the request and the proxy as the source of the resource; and
preparing a second proxy header by rewriting the first proxy header so as to substitute the proxy for the client, and the resource manager for the proxy;
wherein retrieving the resource from the resource manager comprises providing the second proxy header to the resource manager.

29. The medium of claim 28, wherein the instructions comprise further instructions capable of directing the at least one processor to perform:
receiving a third proxy header from the resource manager, the third proxy header identifying the resource manager as the source of the resource, and the proxy as the recipient of the resource;
preparing a fourth proxy header by rewriting the third proxy header so as to substitute the proxy as the source of the resource, and the client as the recipient of the resource; and
wherein providing the resource to the client comprises providing the fourth proxy header to the client.

30. The medium of claim 28, wherein proxy headers are written according to a tag based protocol.

31. The medium of claim 30, wherein the tag based protocol is a selected one of: the HyperText Transport Protocol (HTTP), the HyperText Markup Language (HTML), and the eXtensible Markup Language (XML).

32. The medium of claim 28, wherein the first proxy header comprises a content type identifier identifying a desired format for the resource, and wherein the resource manager stores the resource in a second format different from the desired format, wherein the instructions comprise further instructions capable of directing the at least one processor to perform:
converting the resource from the second format to the first format.

33. The medium of claim 26, wherein the instructions comprise further instructions capable of directing the at least one processor to perform:
receiving a content type identifier from the client identifying a desired format in which to provide the resource to the client; and
converting the resource from a different format utilized by the resource manager into the desired format.

34. The medium of claim 26, wherein the network comprises multiple resource managers providing access to the resource, and wherein the instructions comprise further instructions capable of directing the at least one processor to perform:
retrieving portions of the resource from selected ones of the multiple resource managers.

35. The medium of claim 34, wherein the portions are retrieved in parallel from the selected ones of the multiple resource managers.

36. The medium of claim 35, wherein the instructions comprise further instructions capable of directing the at least one processor to perform:
determining loads for the multiple resource managers; and
selecting among the multiple resource managers according to the loads.

37. The medium of claim 36, wherein the portions are non-overlapping portions of the resource.

38. The medium of claim 26, wherein the instructions comprise further instructions capable of directing the at least one processor to perform:
the resource locator comprising a Uniform Resource Locator (URL); and
inspecting the URL for a path component indicating the URL comprises the at least partially obscured portion.

39. The medium of claim 26, wherein the instructions for validating client authorization to access the resource comprise instructions capable of directing the at least one processor to perform:
hash-encoding an identity value associated with the client; and
providing the hash-encoded identity value and at least a portion of the resource locator to an authorization manager configured to look up the hash-encoded identity value and the at least a portion of the resource locator in an access control table.

40. The medium of claim 1, wherein the client communicates with the proxy by way of an Internet browser.
